(19) United States
(12) Patent Application Publication
(10) Pub. No.: US 2018/0267450 A1
(43) Pub. Date: Sep. 20, 2018

(54) IMAGE FORMING APPARATUS

(71) Applicant: FUJI XEROX CO., LTD., Tokyo (JP)

(72) Inventors: Tomoya KOSUGE, Kanagawa (JP); Keita YANO, Kanagawa (JP); Masahito NIWA, Kanagawa (JP); Yuki KAWAZOE, Kanagawa (JP); Yoshinori SHUIN, Kanagawa (JP)

(73) Assignee: FUJI XEROX CO., LTD., Tokyo (JP)

(21) Appl. No.: 15/699,009

(22) Filed: Sep. 8, 2017

(30) Foreign Application Priority Data
Mar. 14, 2017 (JP) 2017-048415

(51) Int. Cl. G03G 15/23; B41J 3/60

(52) U.S. Cl. CPC G03G 15/234; G03G 15/6579; B41J 3/60

(57) ABSTRACT

An image forming apparatus includes a first outlet portion that allows sheet to be discharged therethrough toward a side surface of the apparatus, a holding portion that holds sheets that are to be reversed, a second outlet portion that is disposed at an upper portion of the apparatus and that allows sheets to be discharged therethrough toward an upper side of the apparatus, a first switching member that changes a destination of a sheet transported thereto between the holding portion and the first outlet portion, and a second switching member that changes a destination of a sheet transported thereto between the second outlet portion and the holding portion or the first outlet portion to which the first switching member has changed the destination.

### CROSS-REFERENCE TO RELATED APPLICATIONS

This application is based on and claims priority under 35 USC 119 from Japanese Patent Application No. 2017-048415 filed Mar. 14, 2017.

### BACKGROUND

### Technical Field

The present invention relates to an image forming apparatus.

### SUMMARY

According to an aspect of the invention, an image forming apparatus includes a first outlet portion that allows sheets to be discharged therethrough toward a side surface of the apparatus, a holding portion that holds sheets that are to be reversed, a second outlet portion that is disposed at an upper portion of the apparatus and that allows sheets to be discharged therethrough toward an upper side of the apparatus, a first switching member that changes a destination of a sheet transported thereto between the holding portion and the first outlet portion, and a second switching member that changes a destination of a sheet transported thereto between the second outlet portion and the holding portion or the first outlet portion to which the first switching member has changed the destination.

### BRIEF DESCRIPTION OF THE DRAWINGS

Exemplary embodiments of the present invention will be described in detail based on the following figures, wherein:

FIG. 1 illustrates a system configuration of an image forming apparatus according to an exemplary embodiment of the present invention to which a postprocessing device is connected;

FIG. 2 illustrates an operation of a sheet discharging unit to discharge a printed sheet from an outlet portion to an output tray;

FIG. 3 illustrates an operation of the sheet discharging unit during double-side printing to discharge a single-side printed sheet to a reversing outlet portion;

FIG. 4 illustrates an operation of the sheet discharging unit performed during double-side printing to withdraw a sheet from the reversing outlet portion and transport the sheet to a sheet reversing path;

FIG. 5 illustrates an operation of the sheet discharging unit to discharge the printed sheet from the outlet portion to feed it to the postprocessing device;

FIG. 6 is a perspective view of switching members;

FIG. 7 is an enlarged perspective view of left end portions of the switching members in the perspective view of FIG. 6, viewed from a different angle;

FIG. 8 illustrates a controlling structure for changing the positions of the switching members;

FIG. 9 illustrates a detailed structure of the switching members;

FIG. 10 is a table showing the relationship between the on/off controlling operation of solenoids, the sheet discharge destination, and the printing type (double-side/single-side);

FIG. 11 illustrates a problem that may occur when the switching member does not include protrusions;

FIG. 12 illustrates an example of a switching signal output from a controller for power saving;

FIG. 13 illustrates protrusions of the switching member having different cross-sectional shapes;

FIGS. 14A, 14B, and 14C illustrate the respective purposes of the cross-sectional shapes A, B, and C; and

FIG. 15 illustrates the structure of an image forming apparatus including two pairs of transport rollers.

### DETAILED DESCRIPTION

Exemplary embodiments of the present invention are described in detail with reference to the drawings.

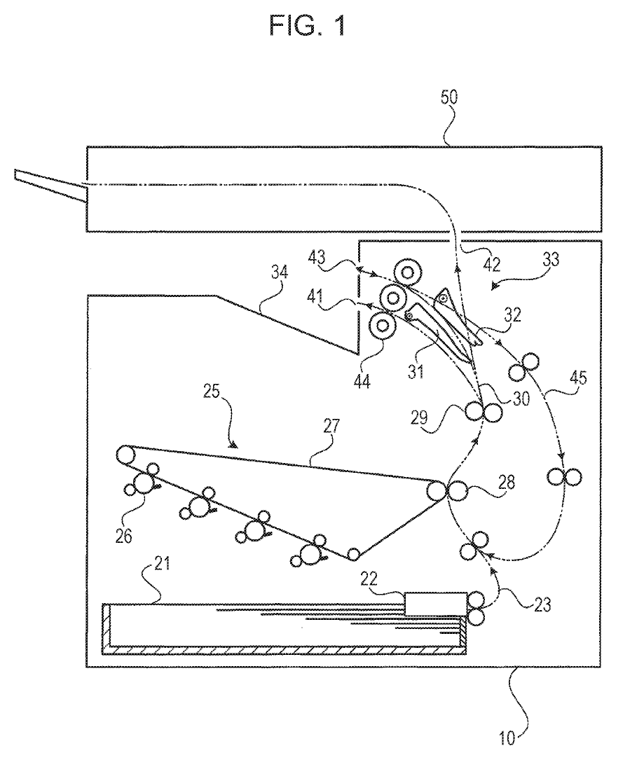

FIG. 1 illustrates a system configuration of an image forming apparatus 10 according to an exemplary embodiment of the present invention to which a postprocessing device 50 is connected.

In the system configuration illustrated in FIG. 1, the postprocessing device 50 is connected to an upper portion of the image forming apparatus 10. The postprocessing device 50 performs postprocessing, such as stapling, on sheets discharged from the image forming apparatus 10 and discharges a bundle of sheets subjected to postprocessing to an output tray.

The image forming apparatus 10 includes an outlet portion 41 that allows sheets to be discharged therethrough to an output tray (paper output tray) 34 without being subjected to postprocessing. The outlet portion 41 has a structure that allows sheets to be discharged toward a side surface of the apparatus. The outlet portion 41 is used to discharge printed sheets not subjected to postprocessing to the output tray 34.

Besides the outlet portion 41, the image forming apparatus 10 includes, at an upper portion of the image forming apparatus 10, an outlet portion 42 that allows sheets to be discharged to an upper side of the apparatus. When sheets subjected to printing by the image forming apparatus 10 are to undergo postprocessing, the sheets are discharged through the outlet portion 42 and fed to the postprocessing device 50.

Besides the outlet portions 41 and 42, the image forming apparatus 10 also includes a reversing outlet portion 43, which allows part of a sheet that is to be reversed for double-side printing to protrude therethrough to the outside of the apparatus. The reversing outlet portion 43 does not allow sheets to be discharged therethrough to the outside of the apparatus, but functions as a holding portion that temporarily holds sheets that are to be reversed.

Now, the entire operation of the image forming apparatus 10 according to the present exemplary embodiment is described. FIG. 1 is a sectional view of the image forming apparatus 10. The image forming apparatus 10 includes a sheet feeding cassette 21, which is equipped with a feeding head 22.

When the image forming apparatus 10 performs printing, the feeding head 22 is actuated to feed printing sheets from the sheet feeding cassette 21 to an image forming unit 25 through a sheet feeding path 23.

The image forming unit 25 includes yellow, magenta, cyan, and black photoconductors 26, arranged side by side, and an intermediate transfer belt 27.

Around each photoconductor 26, devices such as a charging device, an exposure device, a developing device, a first transfer device, and a cleaning device (which are not illustrated) are arranged. A toner image formed on each photoconductor 26 is transferred to the intermediate transfer belt 27. In a black-white mode, only the black photoconductor 26 and the relative devices around the black photoconductor 26 are rendered operable.

A toner image on the intermediate transfer belt 27 is transferred to a transported printing sheet by a second transfer roller 28 and fixed to the printing sheet by a fixing device 29. The printing sheet to which the toner image has been fixed is transported to a sheet discharging unit 33 along a sheet outlet path 30.

The sheet discharging unit 33 transports the sheet transported thereto from the sheet outlet path 30 to the outlet portion 41 when discharging the sheet without performing postprocessing on the sheet. The sheet discharging unit 33 transports the sheet transported thereto from the sheet outlet path 30 to the outlet portion 42 when discharging the printed sheet to the postprocessing device 50 for performing postprocessing on the sheet.

For performing double-side printing, the sheet discharging unit 33 transports a printing sheet subjected to top-side printing to the reversing outlet portion 43, temporarily holds the sheet at the reversing outlet portion 43, and withdraws the sheet held at the reversing outlet portion 43 to transport the sheet to a sheet reversing path 45.

Then, the printing sheet passing along the sheet reversing path 45 is returned to the sheet feeding path 23 again and transported to the image forming unit 25, at which the sheet undergoes bottom-side printing.

The sheet discharging unit 33 includes two switching members 31 and 32 and a tri-roller set 44. The sheet discharging unit 33 controls changing of the destination of sheets transported from the sheet outlet path 30 between the outlet portions 41 and 42 and the reversing outlet portion 43.

Here, the switching member 31 changes the destination of sheets transported from the sheet outlet path 30 between the reversing outlet portion 43 and the outlet portion 41.

The switching member 32 changes the destination of sheets transported from the sheet outlet path 30 between the outlet portion 42 and the reversing outlet portion 43 or the outlet portion 41 to which the destination is changed by the switching member 31.

The tri-roller set 44 includes three transport rollers, including a driving roller and two driven rollers on both sides of the driving roller. The tri-roller set 44 is a transporting unit that transports sheets that have passed by the switching member 31 to the outlet portion 41 or the reversing outlet portion 43. The detailed structure of the tri-roller set 44 is described later.

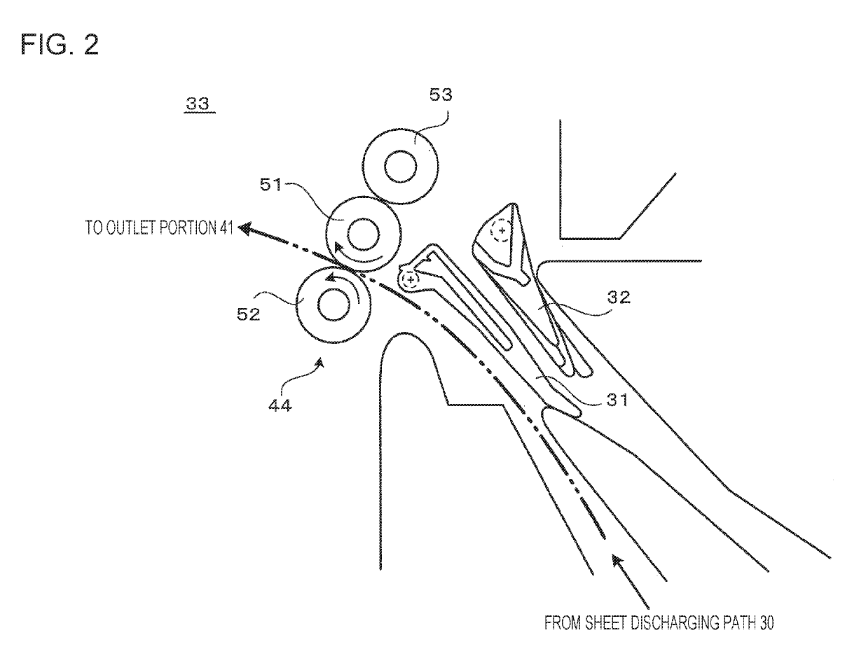

Now, the operation of the sheet discharging unit 33 in the image forming apparatus 10 according to the present exemplary embodiment illustrated in FIG. 1 is described with reference to FIGS. 2 to 5.

First, the operation performed to discharge printed sheets from the outlet portion 41 to the output tray 34 is described with reference to FIG. 2.

Here, before the operation of discharging sheets to the output tray 34 is described, the structure of the tri-roller set 44 in the sheet discharging unit 33 is described with reference to FIG. 2.

As illustrated in FIG. 2, the tri-roller set 44 includes three transport rollers, that is, a driving roller 51, which is driven to rotate by a driving source such as a motor, and two driven rollers 52 and 53, arranged on both sides of the driving roller 51. The driven rollers 52 and 53 are not fed with a driving force from a driving source and are driven to rotate by the driving roller 51.

When the driving roller 51 and the driven roller 52 rotate while holding a sheet transported thereto from the sheet outlet path 30 between themselves, the driving roller 51 and the driven roller 52 transport the sheet transported from the sheet outlet path 30 to the outlet portion 41. When the driving roller 51 and the driven roller 53 rotate while holding a sheet transported thereto from the sheet outlet path 30 between themselves, the driving roller 51 and the driven roller 53 transport the sheet transported from the sheet outlet path 30 to the reversing outlet portion 43 and, when the driving roller 51 rotates reversely, withdraw the sheet held at the reversing outlet portion 43 to transport the sheet toward the sheet reversing path 45.

In FIG. 2, the switching member 31 is changed to such a position as to allow a sheet transported from the sheet outlet path 30 to be transported to a portion between the driving roller 51 and the driven roller 52. Thus, the transported sheet is discharged to the outlet portion 41.

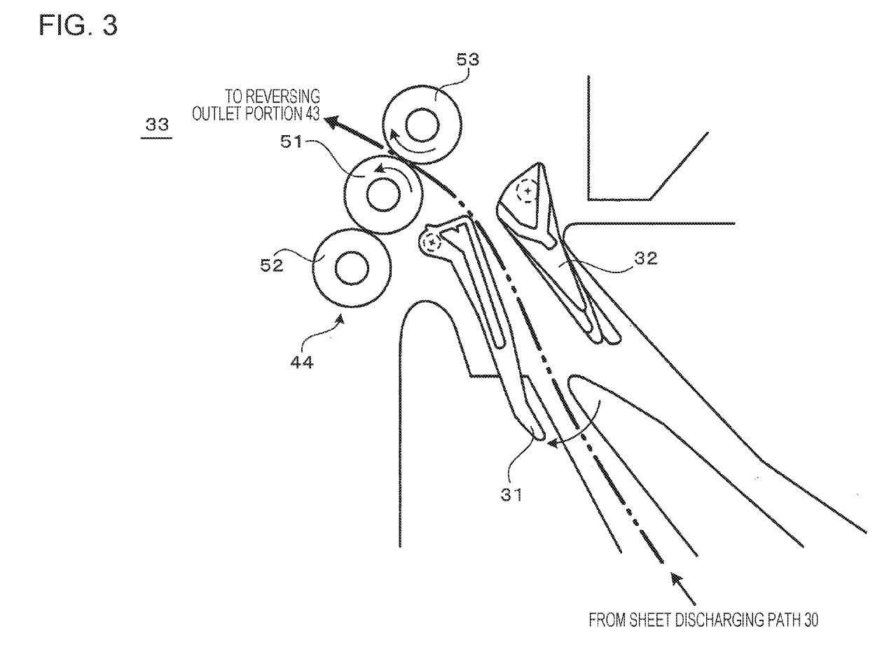

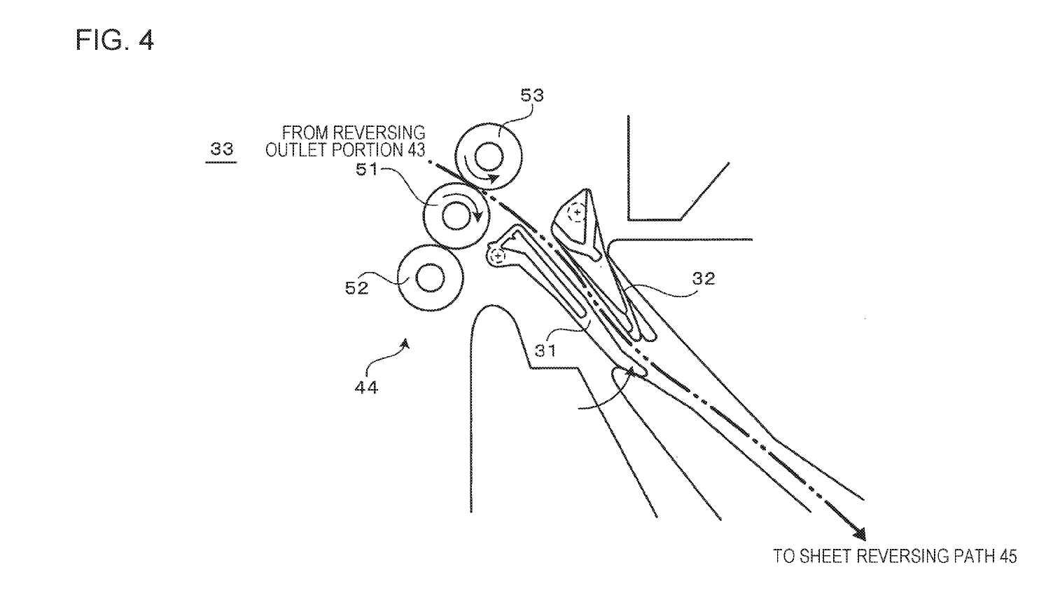

Subsequently, with reference to FIGS. 3 and 4, an operation of, during double-side printing, discharging the sheet subjected to one-side printing to the reversing outlet portion 43 and withdrawing the sheet from the reversing outlet portion 43 to transport the sheet to the sheet reversing path 45 is described.

When sheets are to be reversed, first, as illustrated in FIG. 3, the position of the switching member 31 is changed while the switching member 32 remains in the same position. Thus, a sheet is transported from the sheet outlet path 30 to a portion between the driving roller 51 and the driven roller 53 and then to the outlet portion 43.

As illustrated in FIG. 4, when the switching member 31 is changed to the original position and the driving roller 51 rotates reversely, the sheet whose part protruding through the reversing outlet portion 43 is withdrawn to be transported to the sheet reversing path 45.

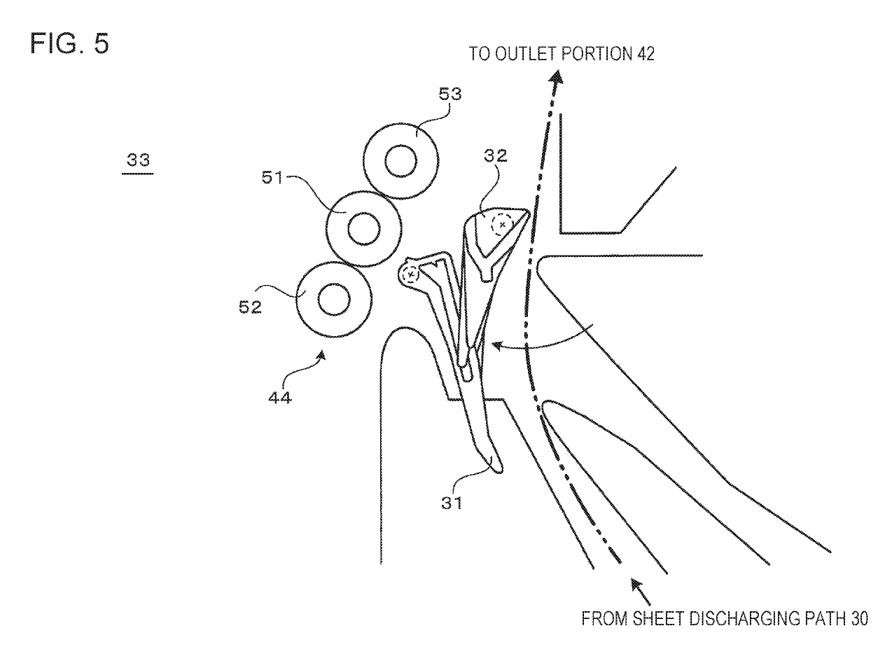

Finally, the operation for discharging the sheet subjected to printing through the outlet portion 42 to feed the sheet to the postprocessing device 50 is described with reference to FIG. 5.

To transport a sheet to the postprocessing device 50 for performing postprocessing on the sheet, the switching member 32 is changed to the position illustrated in FIG. 5. Thus, the switching member 31 is changed to the position illustrated in FIG. 5 from the original position. Then, the sheet transported from the sheet outlet path 30 is guided by the switching member 32 to be transported to the outlet portion 42 and fed to the postprocessing device 50.

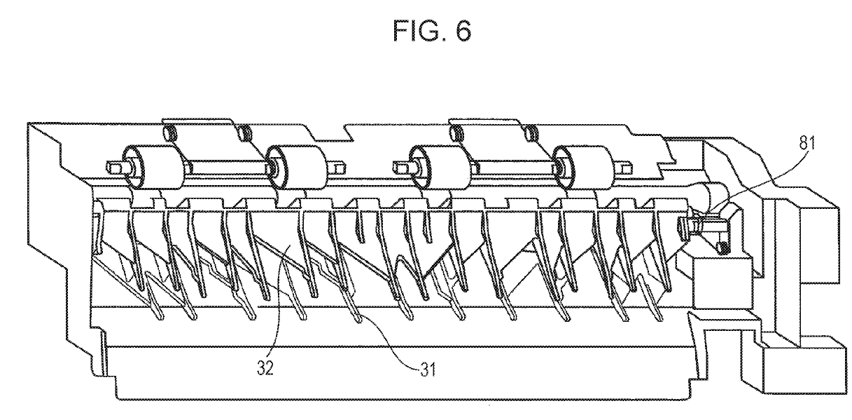

FIG. 6 is a perspective view of the switching members 31 and 32. As illustrated in FIG. 6, the switching members 31 and 32 each have a comblike structure having multiple protrusions.

The switching member 31 has holes corresponding to some of the protrusions of the switching member 32. When, as illustrated in FIG. 5, the switching member 32 is changed to the position in which it allows a transported sheet to be transported toward the outlet portion 42, part of the second switching member 32 overlaps the switching member 31.

As illustrated in FIG. 6, the switching members 31 and 32 are rotatably supported at both ends. The switching member 31 is urged by a spring 81 toward the switching member 32.

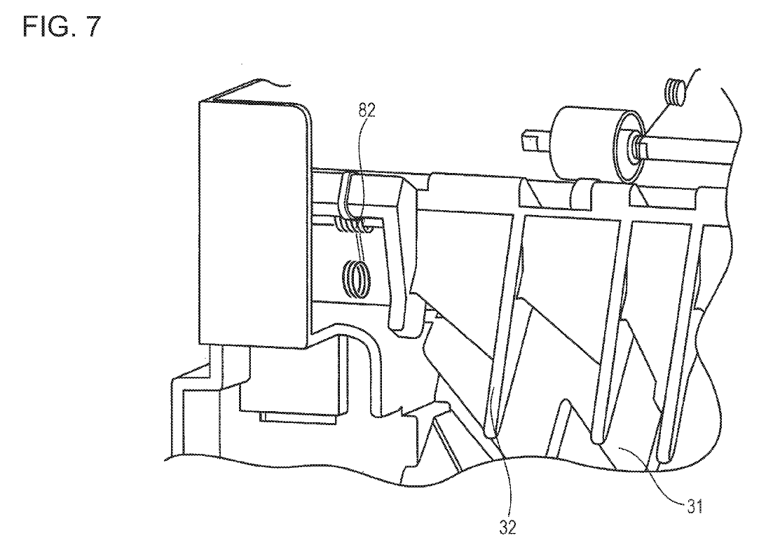

FIG. 7 is an enlarged perspective view of the left end portion of the switching members 31 and 32 in the perspective view of FIG. 6, viewed from a different angle. As illustrated in FIG. 7, a spring 82 is disposed on a rotation shaft of the switching member 32 to urge the switching member 32 in a direction away from the switching member 31. Specifically, the switching members 31 and 32 are respectively urged upward.

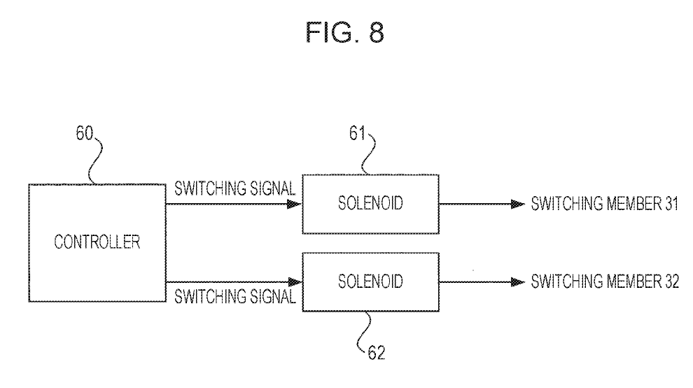

The controlling structure for changing the positions of the switching members 31 and 32 is described with reference to FIG. 8.

As illustrated in FIG. 8, the positions of the switching members 31 and 32 are changed by respectively turning on or off solenoids 61 and 62. The solenoids 61 and 62 are turned on or off in response to switching signals from the controller 60.

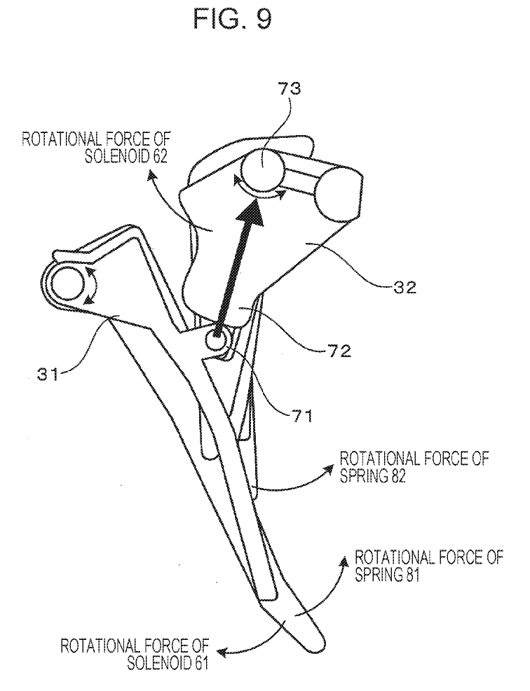

As illustrated in FIG. 9, when the solenoid 61 is turned off, the switching member 31 is changed to the position toward the switching member 32 by the urging force of the spring 81. When the solenoid 61 is turned on, the switching member 31 is changed to the position away from the switching member 32.

When the solenoid 62 is turned off, the switching member 32 is changed to the position away from the switching member 31 by the urging force of the spring 82. When the solenoid 62 is turned on, the switching member 32 is changed to the position toward the switching member 31.

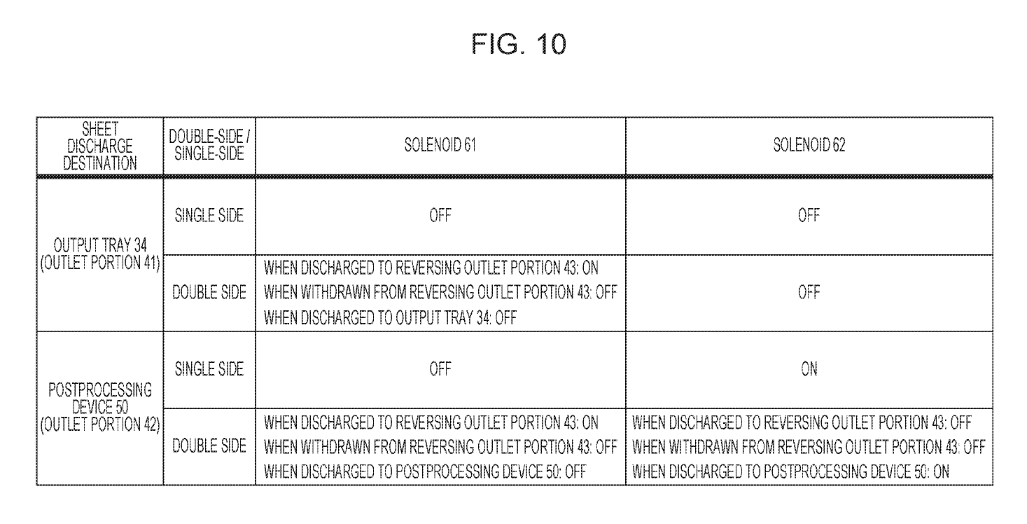

FIG. 10 shows the relationship between the on/off controlling operation of the solenoids 61 and 62, the sheet discharge destination, and the printing type (double-side/single-side).

When the output tray 34 is selected as the discharging destination and single-side printing is to be performed, both solenoids 61 and 62 are turned off and the switching members 31 and 32 are controlled to be in the positions illustrated in FIG. 2.

When the output tray 34 is selected as the discharging destination and double-side printing is to be performed, the solenoid 62 is constantly kept off. On the other hand, the solenoid 61 is turned on to discharge a sheet to the reversing outlet portion 43, as illustrated in FIG. 3, and is turned off to withdraw a sheet from the reversing outlet portion 43, as illustrated in FIG. 4. When a printing sheet subjected to double-side printing is to be discharged to the outlet portion 41, the solenoid 61 is turned off.

When the postprocessing device 50 is selected as the discharging destination and single-side printing is to be performed, the solenoid 61 is temporarily turned on first, and then the solenoid 62 is turned on. Thereafter, the solenoid 61 is turned off. Finally, the solenoid 61 is off and the solenoid 62 is on. As illustrated in FIG. 9, the switching member 31 includes a projection 71 and the switching member 32 includes a receiver 72 at a position corresponding to the projection 71. When the switching member 31 is pressed toward the switching member 32 by the urging force of the spring 81 and is in such a position as to overlap the switching member 32, the projection 71 presses the receiver 72. Here, the direction in which the projection 71 presses the receiver 72 is a direction toward a hinged support 73 of the switching member 32.

Specifically, the rotational force (moment) at the switching member 32 resulting from a force exerted on the switching member 32 by the switching member 31 is almost zero.

The switching member 32 thus holds the switching member 31 at the position at which a force is exerted toward the hinged support when the switching member 32 is in such a position as to overlap the switching member 31. Even when the solenoid 61 is off, the switching member 32 may hold the switching member 31 in the position away from the direction in which the switching member 31 is urged by the spring 81 without increasing a load on the solenoid 62, which changes the position of the switching member 32.

When the postprocessing device 50 is selected as the discharging destination and double-side printing is to be performed, the control on the solenoids 61 and 62 to reverse a sheet is similar to that performed when the output tray 34 is selected as the discharging destination. The control on the solenoids 61 and 62 to discharge a sheet to the postprocessing device 50 is similar to that performed when single-side printing is performed.

The projection 71 of the switching member 31 illustrated in FIG. 9 has a mechanism to prevent the switching members 31 and 32 from becoming inoperable as a result of becoming stuck when the projection 71 comes into contact with the receiver 72 of the switching member 32.

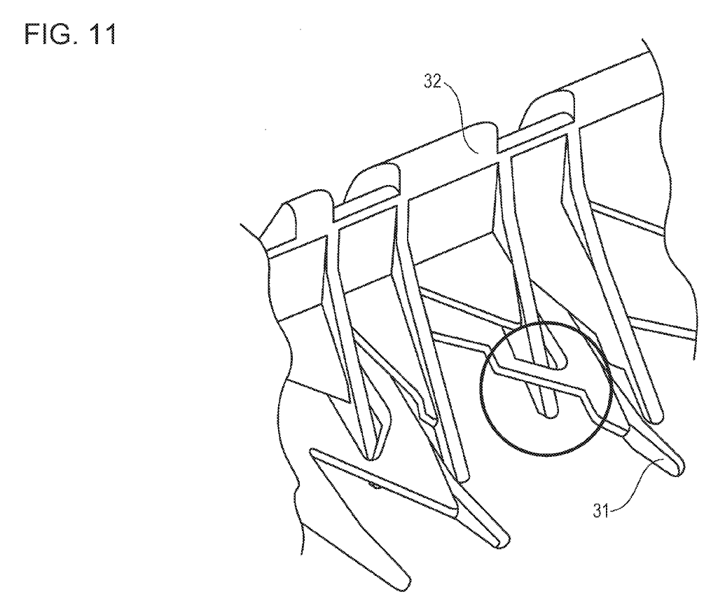

As described above, in the present exemplary embodiment, the switching member 31 has holes. When one protrusion of the switching member 32 overlaps a corresponding one of the holes, the switching members 31 and 32 overlap each other to allow sheets to pass thereby to the outlet portion 42. If the switching member 31 has no projection 71, a protrusion of the switching member 32 would enter the hole of the switching member 31 deeper than intended, as illustrated in FIG. 11, and the switching members 31 and 32 may become caught and inoperable.

To address this, in the present exemplary embodiment, the switching member 31 includes the projection 71 to prevent the switching members 31 and 32 from becoming caught.

Here, to control the switching members 31 and 32 such that the switching members 31 and 32 do not interfere with each other is possible by controlling the operation timing of the solenoids 61 and 62. Specifically, when the switching member 32 is to be lowered, the switching member 32 may be lowered in the state where the switching member 31 is completely lowered. When the switching member 31 is to be raised, the switching member 31 may be raised in the state where the switching member 32 is completely raised. In some cases, however, the above operation timing may be irregularly broken to handle the case, for example, where a paper jam occurs and a user directly touches the sheet discharging unit 33 to remove the jammed sheet. Thus, providing the projection 71 to the switching member 31 is desirable to prevent the switching members 31 and 32 from physically interfering with each other.

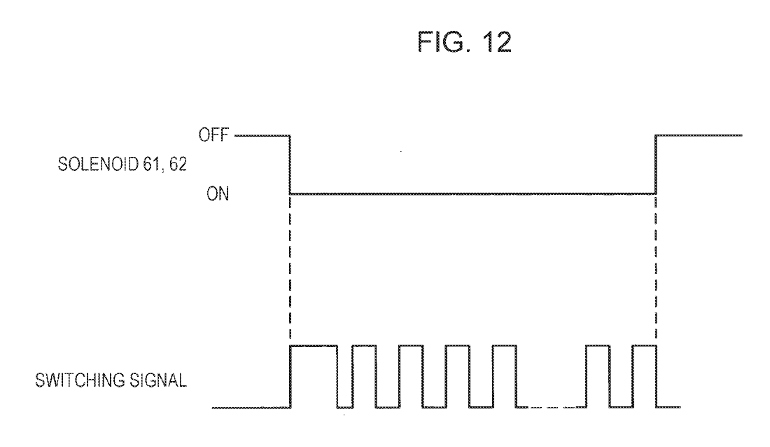

To keep the solenoids 61 and 62 on, an electric current has to be continuously passed through the solenoids 61 and 62. Thus, electricity is kept being consumed to keep the solenoids 61 and 62 on. Power consumption may be reduced if, as illustrated in FIG. 12, the switching signal from the controller 60 is an intermittent signal that keeps the solenoids 61 and 62 on within a sustainable range, instead of a signal that constantly keeps the solenoids 61 and 62 on.

Specifically, as illustrated in FIG. 12, power consumption may be reduced when the switching signal is a pulse signal whose duty cycle is controlled, instead of a continuous signal. The duty cycle is increased to change the states of the solenoids 61 and 62 and the duty cycle is reduced after the states of the solenoids 61 and 62 are changed. When the duty cycle is changed immediately before the switching members 31 and 32 collide with each other in response to changing the states of the solenoids 61 and 62, the sound resulting from the collision of the switching members 31 and 32 may be reduced.

The sectional shapes of the switching members 31 and 32 are described now.

The switching members 31 and 32 have structures that change the sheet transport direction when the sheets touch the switching members 31 and 32. To allow sheets to pass thereby smoothly, the switching members 31 and 32 each have a wing-shaped cross section.

The switching member 32 has a cross section whose length is shorter than that of the cross section of the switching member 31 to smoothly transport sheets to the outlet portion 42 and to the postprocessing device 50.

To allow sheets to pass thereby further smoothly, the switching member 32 has multiple different types of cross sections at positions in an axially supported direction.

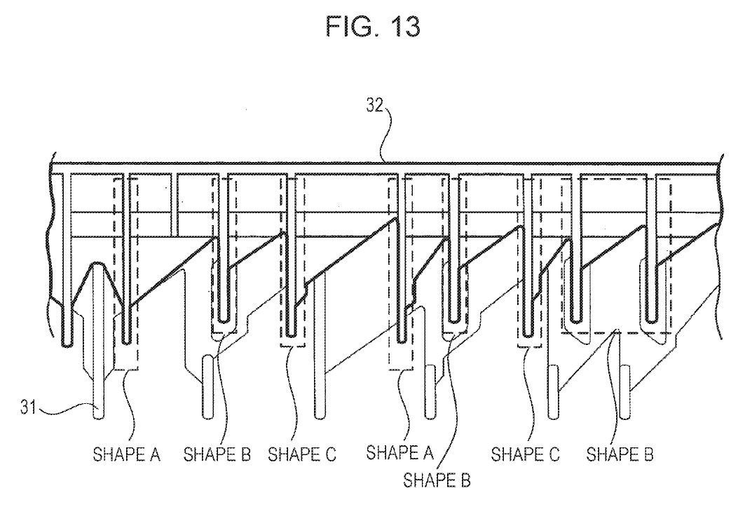

Specifically, as illustrated in FIG. 13, protrusions (wing-shaped portions) of the switching member 32 that touch the sheets have different types of cross sections at different positions in the axially supported direction. In FIG. 13, the switching member 32 mainly has three types of cross sections, that is, shape A, shape B, and shape C, at positions in the axial direction. These three types of cross sections have different functions.

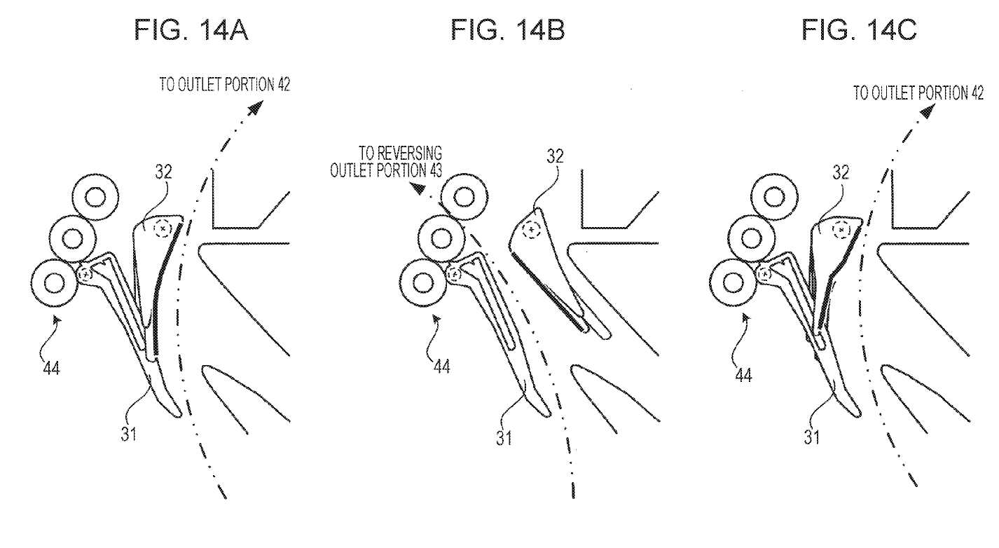

Specifically, as illustrated in FIG. 14A, shape A is a sheet-touch cross section when the switching member 32 is lowered to form a discharging path leading to the postprocessing device 50.

Shape B is a sheet-touch cross section when the switching member 32 is raised to form a discharging path leading to the reversing outlet portion 43.

Shape C is an intermediate shape between shape B and shape A and is a cross section when the switching member 32 is lowered to a position slightly lower than the sheet-touch cross section of shape A.

Since the switching member 32 has multiple different types of cross sections, troubles that may occur during sheet transportation along the sheet outlet paths formed by the switching member 32 may be reduced.

Although the above-described sheet discharging unit 33 has a structure that includes the tri-roller set 44, the present invention is also applicable to a structure including four transport rollers to discharge sheets to the outlet portion 41 and the reversing outlet portion 43.

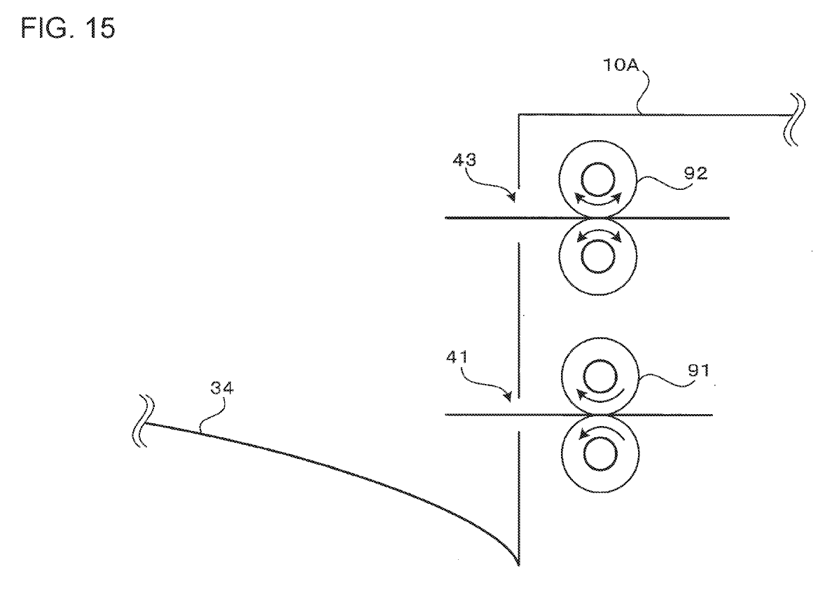

For example, the present invention is also applicable to an image forming apparatus 10A, illustrated in FIG. 15, which includes a pair of transport rollers 91 and a pair of transport rollers 92, which discharge sheets to the outlet portion 41, discharge sheets to the reversing outlet portion 43, and withdraw sheets from the reversing outlet portion 43.

### Modification

In the above-described exemplary embodiment, the postprocessing device is connected at an upper portion of an image forming apparatus. The present invention, however, is not limited to this structure. For example, the present invention is also applicable to a structure in which an output tray, such as a face-up tray, is disposed at an upper portion of the apparatus and an outlet portion that allows sheets to be discharged therethrough to the output tray is disposed at an upper portion of the apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus, comprising:
a first outlet portion that allows sheets to be discharged therethrough toward a side surface of the apparatus;
a holding portion that holds sheets that are to be reversed;
a second outlet portion that is disposed at an upper portion of the apparatus and that allows sheets to be discharged therethrough toward an upper side of the apparatus;
a first switching member that changes a destination of a sheet transported thereto between the holding portion and the first outlet portion; and
a second switching member that changes a destination of a sheet transported thereto between the second outlet portion and the holding portion or the first outlet portion to which the first switching member has changed the destination.

2. The image forming apparatus according to claim 1,
wherein the second switching member has a comblike structure including a plurality of protrusions,
wherein the first switching member has a plurality of holes corresponding to the plurality of protrusions of the second switching member, and
wherein, when the second switching member is changed so as to allow a sheet transported thereto to be transported to the second outlet portion, part of the second switching member overlaps the first switching member.

3. The image forming apparatus according to claim 2, wherein, when the second switching member is positioned so as to overlap the first switching member, the second switching member holds the first switching member in a position in which a force is exerted toward a hinged support of the second switching member.

4. The image forming apparatus according to claim 1, further comprising:
a transporting unit that transports a sheet that has passed by the first switching member to the first outlet portion or the holding portion,
wherein the transporting unit includes a driving roller and two driven rollers disposed on both sides of the driving roller.

5. The image forming apparatus according to claim 1, wherein the first and second switching members each have a wing-shaped cross section.

6. The image forming apparatus according to claim 5, wherein the second switching member has a cross section whose length is shorter than a length of a cross section of the first switching member.

7. The image forming apparatus according to claim 5, wherein the second switching member has different types of cross sections at different positions in an axially supported direction.
